(19) United States
(12) Patent Application Publication
(10) Pub. No.: US 2015/0227528 A1
(43) Pub. Date: Aug. 13, 2015

(54) SENTIMENT-BASED QUERY PROCESSING SYSTEM AND METHOD

(71) Applicant: Korea University Research and Business Foundation, Seoul (KR)

(72) Inventor: Jaewoo Kang, Seoul (KR)

(21) Appl. No.: 14/693,188

(22) Filed: Apr. 22, 2015

Related U.S. Application Data
(63) Continuation of application No. PCT/KR2013/009582, filed on Oct. 25, 2013.

(30) Foreign Application Priority Data
Oct. 26, 2012 (KR) 10-2012-0119977

(51) Int. Cl. G06F 17/30

(52) U.S. Cl. CPC G06F 17/3053; G06F 17/30336; G06F 17/30864

(57) ABSTRACT

A sentiment-based query processing system is provided. A sentiment-based query processing system includes an index establishing unit that divides at least one document into at least one segment, generates an aspect-sentiment pair by extracting an aspect keyword representing an aspect of an object of opinion described in the segment and a sentiment keyword representing document writer's sentiment regarding the aspect, and establishes an index including contents of the segment and the aspect-sentiment pair; an index storing unit that stores the index; and a query processing unit that processes a query based on the index stored in the index storing unit, so as to search and return a document describing opinion related to the query or an object describing opinion related to the query.

### CROSS-REFERENCE TO RELATED APPLICATION

This Application is a continuation application of PCT Application No. PCT/KR2013/009582 filed on Oct. 25, 2013, which claims the benefit of Korean Patent Application No. 10-2012-0119977 filed on Oct. 6, 2012, the entire disclosures of which are incorporated herein by reference.

### TECHNICAL FIELD

The embodiments described herein pertain generally to a system and a method for processing a sentiment-based query.

### BACKGROUND ART

The technology of processing a user's query is one of the fields that have garnered the most attention in recent years. Especially, with respect to the query processing technology, there have been conducted many researches for enabling processing of an objective aspect of a query object, and furthermore, sentiment regarding the corresponding aspect.

For example, if the query object is a movie, the query processing technology is intended to enable processing of a query on objective aspects, such as directing, a movie scenario and main characters of the movie, and furthermore, a query on subjective sentiment regarding the corresponding aspects, such as how good the directing was, and whether the movie scenario was exciting.

A relevant conventional technology has a problem since accuracy of a search result returned in response to a query on subjective opinion or sentiment is low. For example, in the conventional technology, in response to a query of “a movie with good acting,” a document describing opinion that “the scenario was good, but the actors′/actresses' acting was not good” may be searched. Accordingly, a user needs to study and filter the search result less related to the query by himself/herself. Further, a user should experience inconvenience of retrying a new query or the like.

Accordingly, a system and a method for processing a sentiment-based query, which are capable of processing a query by reflecting subjective sentiment and opinion and returning an accurate search result, are necessary. Since the system and the method for processing a sentiment-based query can return only a result highly related to a query even when the scope of the query is somewhat vague because of including subjective sentiment, user's search convenience can be greatly improved.

With respect to the query processing, Korean Patent Application Publication No. 10-2009-0048997 (“System and Method for Gathering Public Opinion Data using Keyword and Recording Medium”) describes collecting public opinion materials based on keywords.

In addition, Korean Patent Application Publication No. 10-2011-0038247 (“Apparatus and method for extracting keywords”) describes extracting keywords from postings and expanded similar documents.

### DISCLOSURE OF THE INVENTION

### Problems to be Solved by the Invention

In view of the foregoing problems, example embodiments provide a system and a method for processing a sentiment-based query, which are capable of processing a query on subjective sentiment and returning an accurate search result.

### Means for Solving the Problems

In accordance with a first aspect of example embodiments, there is provided a sentiment-based query processing system. A sentiment-based query processing system include an index establishing unit that divides at least one document into at least one segment, generates an aspect-sentiment pair by extracting an aspect keyword representing an aspect of an object of opinion described in the segment and a sentiment keyword representing document writer's sentiment regarding the aspect, and establishes an index including contents of the segment and the aspect-sentiment pair; an index storing unit that stores the index; and a query processing unit that processes a query based on the index stored in the index storing unit, so as to search and return a document describing opinion related to the query or an object describing opinion related to the query.

In accordance with second first aspect of example embodiments, there is provided a sentiment-based query processing method using a sentiment-based query processing system. A sentiment-based query processing method using a sentiment-based query processing system includes dividing at least one document into at least one segment including at least one minimum phrase, clause or sentence having identical semantic relationship; generating an aspect-sentiment pair by extracting an aspect keyword representing one aspect of an object in opinion described in the segment and a sentiment keyword representing document writer's sentiment regarding the aspect; establishing an index including contents of the segment and the aspect-sentiment pair; implementing parsing of a received query, so as to calculate a polarity code of the query based on keywords representing sentiment in the query, and remove a keyword representing only polarity of sentiment from the keywords representing sentiment; examining relationship between each segment included in the index and the query based on the contents of the segment and the aspect-sentiment pair to calculate a segment score; and summing up the segment scores calculated by the segment examining unit to examine relationship of the document or object to the query.

### Effect of the Invention

In the system and method for processing a sentiment-based query in accordance with the example embodiments, an effect in returning an accurate search result can be expected.

In addition, since the example embodiments return only a result highly related to a query even when the query includes subjective sentiment, and thus, the scope thereof is somewhat vague, user's search convenience can be significantly improved. For example, a user does not need to study and filter a result less related to a query by himself/herself. Especially, a user does not need to prudently select query keywords and expressions in order to obtain his/her desired result. Since it is unnecessary to limit a query keyword only to a specific scope of a value for an objective aspect, a user may use an unclear concept that he/she desires to search as it is, without refining the unclear concept to specific query words.

Accordingly, the example embodiments may be used as means for facilitating user's decision making. Thus, since a user can effectively search other people's opinion through the example embodiments, he/she can consider many other people's experience and opinion in making his/her decision.

Furthermore, the example embodiments are simple and effective in the query processing process. For example, since the example embodiments do not expand a keyword, which is included in a query to represent only polarity of sentiment, to a synonym or a near-synonym and consider only a polarity code of the sentiment, it is possible to thoroughly search opinion related to the query with a fast query processing speed.

### BRIEF DESCRIPTION OF THE DRAWINGS

FIG. 1 shows a structure of a sentiment-based query processing system in accordance with an example embodiment.

FIG. 2 shows a polarity weighting score of sentiment in accordance with an example embodiment.

FIG. 3 shows a document representing opinion in accordance with an example embodiment.

FIG. 4 shows segment contents and aspect-segment pairs included in a segment of FIG. 3.

FIG. 5 shows a parsed query in accordance with an example embodiment.

FIG. 6 shows a parsed query in accordance with another example embodiment.

FIG. 7 shows a parsed query in accordance with another example embodiment.

FIG. 8 shows an example for examining the segment of FIG. 4 with respect to the query of FIG. 5.

FIG. 9 shows an example for examining the segment of FIG. 4 with respect to the query of FIG. 6.

FIG. 10 shows an example for examining the segment of FIG. 4 with respect to the query of FIG. 7.

FIG. 11 shows flow of an index establishing method in accordance with an example embodiment.

FIG. 12 shows flow of a query parsing method in accordance with an example embodiment.

FIG. 13 shows flow of a segment examining method in accordance with an example embodiment.

### DETAILED DESCRIPTION

Hereinafter, example embodiments will be described in detail with reference to the accompanying drawings so that inventive concept may be readily implemented by those skilled in the art. However, it is to be noted that the present disclosure is not limited to the example embodiments, but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element. Further, the term “comprises or includes” and/or “comprising or including” means that one or more other components, steps, operations, and/or the existence or addition of elements are not excluded in addition to the described components, steps, operations and/or elements.

FIG. 1 is a block diagram showing a sentiment-based query processing system 10 in accordance with an example embodiment.

First, with reference to FIG. 1, the sentiment-based query processing system 10 in accordance with the example embodiments includes a sentiment score dictionary 200, an index storing unit 100, an index establishing unit 300, and a query processing unit 400. To briefly describe the components, the index establishing unit 300 establishes an index to be used for query processing based on at least one document describing opinion and stores the index in the index storing unit 100. Once the index is stored in the index storing unit, the query processing unit 400 processes a query based on the index stored in the index storing unit 100 and a polarity weighting score of sentiment defined in the sentiment score dictionary 200. In accordance with an example embodiment, the index divides a document into segments based on a semantic unit. In this case, the index may include aspect-sentiment pairs together with segment contents.

Prior to detailed description in this regard, it is first described what are an aspect and sentiment.

An aspect means various features of a query object. For example, an aspect of a book, which is a query object, includes a title, an author, a domain, a cost and others of the book. In this case, if the book is a translation, the aspect of the book may further include a translator and others. A user may search his/her desired object by using an aspect of a query. For example, a user may search a book including “Holmes” in its title, or a book written by the author “Conan Doyle.” Here, “Holmes” and “Conan Doyle” are objective values of an aspect. Conducting a search by using objective values of an aspect can be accomplished by a conventional query processing technology.

However, for the objective query, a user searching the query should have exact information. For example, the user should have, in advance, the information that the author of the book that the user desires to search is “Conan Doyle.” However, the user may want to conduct the search by using a highly subjective query, i.e., “a detective novel author who has created the most attractive main character,” rather than the exact name of the author. This subjective query may be used when a user does not have exact information, or wants to see other users' opinion.

In case of this query like the above-described example, the query on the aspect, i.e., an author, includes the subjective sentiment of “the most attractive.” In order to process the sentiment-based subjective query, the example embodiments use an aspect-sentiment pair, which is generated by extracting, from a document describing opinion, an aspect and document writer's sentiment regarding the corresponding aspect.

For example, it is assumed that a document including opinion that “Agatha Christie's defective story is exciting and attractive, but the main character, Poirot, does not seem to be so attractive. The author, Agatha Christie, has created the somewhat ridiculous main character.” has been returned in response to the above-described query. In this case, since the returned document includes the opinion that the “story” is attractive, and the “main character” is ridiculous, it is less related to the user's query. Thus, this result is inaccurate. In this example, despite that the document describes the opinion that “the story itself is attractive, but the main character, Poirot, is not attractive,” the document has been returned in response since it includes the words “attractive” and “main character.”

As shown from the example above, for the conventional technology, there are many cases where an inaccurate result is returned in response to a query including subjective sentiment. On the other hand, the sentiment-based query processing system 10 in accordance with an example embodiment can return an accurate search result desired by a user even in response to a subjective sentiment-based query, by using an aspect-sentiment pair. Accordingly, as described above, the sentiment-based query processing system 10 improves user's search convenience.

In order to return an accurate search result in response to a sentiment-based query, the sentiment-based query processing system 10 may divide a document into minimum phrase, clause or sentence units, which have identical semantic relationship, and index each of the divided segments.

For example, if a query object is a movie, a document describing opinion that “I went to watch a movie with my girlfriend last weekend. The scenario was good, but the actors/actresses' acting was not good. But, I think the movie was decent overall. The movie was enjoyable.” may be considered.

Like the above-described example, since this document includes “acting” and “good,” it may be returned as a search result for the query of “a movie with good acting.” In order to avoid that a document is found as a search result depending on consistency in words, the sentiment-based query processing system 10 divides the above document into a multiple number of segments, i.e., “I went to watch a movie with my girlfriend last weekend,” “The scenario was good,” “but the actors/actresses' acting was not good,” “But, I think the movie was decent overall,” and “The movie was enjoyable.” And, the sentiment-based query processing system 10 may index each of the divided segments. Then, since any of the segments does not match the query of “a movie with good acting,” the document is not returned as a search result.

However, while this approach contributes to improving search accuracy, it may cause another problem since the unit of the segments is too small. For example, in case of a query of “a good movie to watch with a girlfriend,” despite that the above-exemplified document is related to the query, it is not returned as a search result. Since the first segment includes “girlfriend” and “watch,” it matches the query. However, since the contents of the segment include no sentiment, sentiment regarding the “movie” cannot be determined only from the segment. Thus, in order to process a query including sentiment or the like, opinion needs to be processed by one segment.

Accordingly, the sentiment-based query processing system 10 divides a document into topic units to include a multiple number of segments. A method for the division into topic units is not limited. Conventional technologies known through natural language processing researches may be used, and simply splitting a document into several sentence units is possible. For example, if a pre-designated sentence unit is five (5), a document may be split and divided by five (5) sentences.

In order to enable a large unit of segments and avoid that an inaccurate search result is returned as in the above-described example, the sentiment-based query processing system 10 establishes an index to include aspect-sentiment pairs together with segments. Accordingly, the index establishing unit 300 in accordance with an example embodiment divides at least one document into at least one segment. Also, the index establishing unit 300 generates an aspect-sentiment pair by extracting an aspect keyword representing an aspect regarding an object of opinion described in a segment and a sentiment keyword representing document writer's sentiment regarding the aspect. The index establishing unit 300 establishes an index including contents of segments and aspect-sentiment pairs and stores the index in the index storing unit 100.

In addition, the query processing unit 400 in accordance with an example embodiment processes a query based on the index stored in the index storing unit 100. Also, the query processing unit 400 searches and returns a document describing opinion related to a query or an object described by opinion related to a query. The sentiment-based query processing system 10 in accordance with the example embodiments may establish an index by domains. For example, if a query object is a movie, the sentiment-based query processing system 10 may implement processing of a query based on an index established for a document describing opinion on the movie. For another example, if a query object is a book, the sentiment-based query processing system 10 may implement processing of a query based on an index established for a document describing opinion on the book.

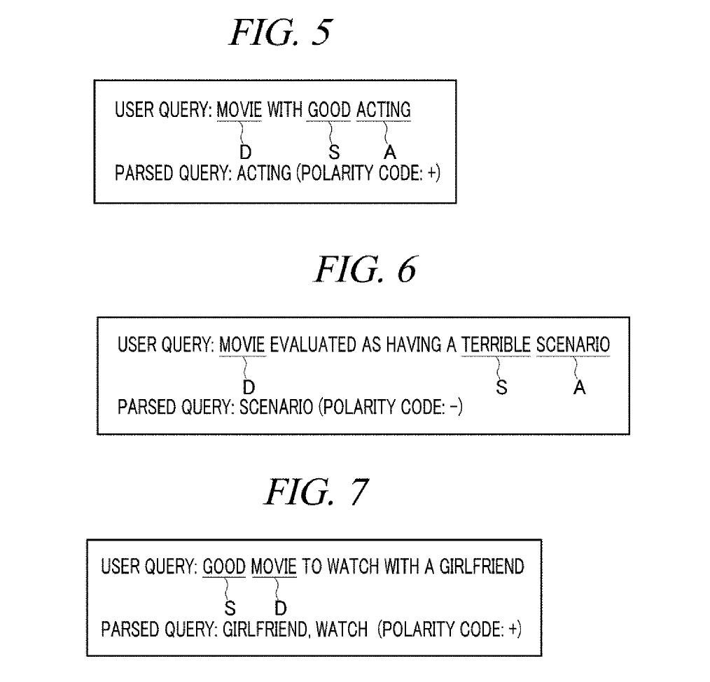

This example embodiment may implement processing of a query after removing a keyword representing a domain. Thus, in the example embodiment, indexes that need to be searched are reduced so that user's search speed for a query can be improved. In addition, in the example embodiment, it is also possible to implement processing of a query by treating and indexing a domain merely as one aspect. Detailed description in this regard will be provided later by using FIG. 5 to FIG. 7. As described above, in an example embodiment, the query processing unit 400 may return a document describing opinion related to a query. For example, for a query of “a movie with good acting,” a document describing that “I was thrilled when the main actor was acting to stare at the screen in the last scene. He is a truly great actor” may be returned.

In this case, a method for enabling the query processing unit 400 to return a document is not limited. The query processing unit 400 may return all contents of a document or contents of a part of a document, which includes corresponding opinion. In addition, the query processing unit 400 may return URL of a document. Especially, if a document describing opinion is an online review, the query processing unit 400 preferably returns contents of the corresponding part and URL of the document together. In addition, the query processing unit 400 may return detailed information about an object described by a document related to a query. For example, if a document related to a query is an opinion document regarding the movie “Memories of Murder,” the query processing unit 400 may return detailed information about the movie “Memories of Murder.”

The query processing unit 400 includes a query parsing unit 410 and a segment examining unit 420. Here, the query parsing unit 410 implements parsing for a query. The segment examining unit 420 examines relationship to a query based on segment contents of each segment and an aspect-sentiment pair included in an index to calculate a segment score. The segment scores calculated by the segment examining unit 420 are summed up, and used to examine relationship between each document including the corresponding segment or an object described by the corresponding segment and a query.

The query parsing unit 410 may implement pre-processing such as removing a stop word; however, since this technology has been conventionally known, detailed description in this regard is omitted herein. The query parsing unit 410 parses a query to extract keywords. In this case, the keywords may include a keyword representing an aspect, a keyword representing sentiment, a keyword representing a domain, and others. As described above, in an example embodiment, if a domain is excluded upon user query search, a keyword representing a domain may be removed.

If a query includes two (2) or more keywords representing an aspect, the query parsing unit 410 divides the query into at least one semantic unit based on the keywords representing an aspect. The segment examining unit 420 calculates a segment score for each of the semantic units divided in the query parsing unit 410. For example, in case of a query of “a movie with good acting and scenario,” the segment examining unit 420 divides the query into two (2) semantic units, i.e., “good acting” and “good scenario” to be individually processed. Thereafter, the segment examining unit 420 may calculate a segment, document or object score for the entire query, by summing up segment, document or object scores calculated for the respective semantic units.

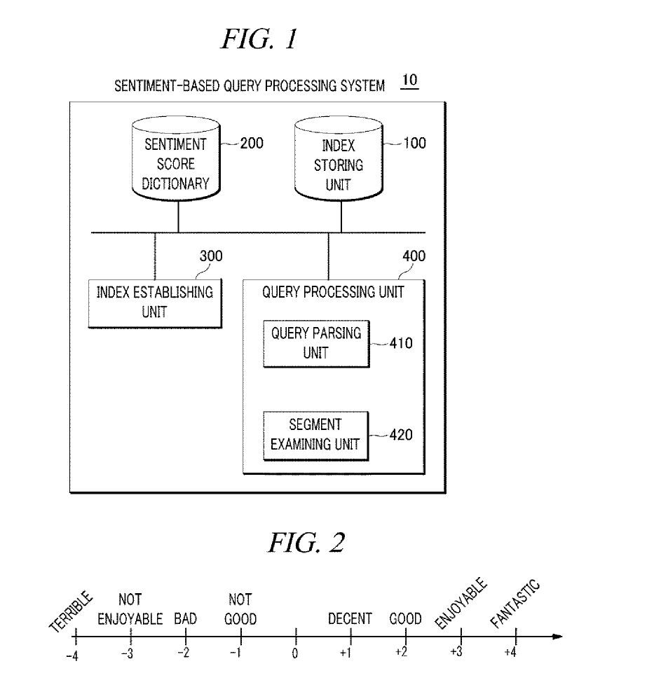

The query parsing unit 410 calculates a polarity code of a query, based on a keyword representing sentiment. Also, the query parsing unit 410 removes a keyword representing only polarity of sentiment from polarity codes of keywords included in a query. For description in this regard, FIG. 2 is first referred-to.

FIG. 2 shows a polarity weighting score of sentiment in accordance with an example embodiment.

For convenience in description, FIG. 2 shows polarity and a weighting of sentiment on a vertical line. Positive sentiment regarding an object has polarity of “+,” and negative sentiment has polarity of “−.” In addition, positive or negative intensity may be expressed by a weighting. For example, in the present example embodiment, “good” and “bad” are defined by “+2” and “−2,” respectively. In addition, in the present example embodiment, “fantastic” and “terrible,” which have higher intensity than “good” and “bad,” are defined by “+4” and “−4,” respectively. Since there are various expressions representing positive and negative sentiment, one of ordinary skill in the art can easily understand that the present example embodiment merely describes several examples for convenience in description.

The polarity weighting score of sentiment may be pre-defined in the sentiment score dictionary as described above. In addition, the polarity weighting score pre-defined in the sentiment score dictionary is referred-to by the query processing unit 400. For example, the query parsing unit 410 included in the query processing unit 400 calculates a polarity code of a query by using the polarity weighting score. The segment examining unit 420 included in the query processing unit 400 calculates a sentiment score of an aspect-sentiment pair based on the polarity weighting score.

Returning to FIG. 1, since there are various expressions representing positivity or negativity, the query parsing unit 410 in accordance with an example embodiment calculates polarity codes of a query based on keywords representing sentiment, and then, removes a keyword only representing polarity of sentiment from the polarity codes.

For example, if a query includes a keyword representing positive sentiment of “good” like a query of “a movie with good acting,” it is preferable to allow that a document describing opinion of “the acting is good” or “the acting is fantastic” can also be searched. To this end, the query parsing unit 410 may consider a method of expanding the query to a synonym, a near-synonym or the like of the word “good.” However, since there are many expandable synonyms or near-synonyms of the word “good,” it is very inefficient for the query parsing unit 410 to expand the query to include all synonyms or near-synonyms of the word “good.” Further, even though the query is expanded to include all synonyms or near-synonyms, a document describing opinion including a corresponding expanded keyword may not be searched.

An example embodiment has resolved this problem, by considering only a polarity code of a keyword representing polarity of sentiment, instead of removing the corresponding keyword. For example, the query parsing unit 410 calculates a polarity code of “+,” i.e., “+1” for positive sentiment keywords such as “good,” “great” and “fantastic.” Also, the query parsing unit 410 calculates a polarity code of “−,” i.e., “−1” for negative sentiment keywords such as “bad,” “not good” and “terrible.” Then, the query parsing unit 410 removes a positive sentiment keyword and a negative sentiment keyword, which represent only polarity of sentiment. However, if a keyword, like “enjoyable” or “not enjoyable,” includes additional sentiment information, as well as polarity of sentiment, the query parsing unit 410 calculates a polarity code of the keyword and does not remove the keyword.

For an additional example, since “awesome” and “poor” represent only polarity of sentiment, the query parsing unit 410 calculates polarity codes and removes the keywords. In addition, since “interesting,” “impressive,” “exciting” and others include additional sentiment information, as well as polarity of sentiment, the query parsing unit 410 does not remove the keywords after calculating polarity codes thereof.

Since the query parsing unit 410 removes a keyword if the keyword includes only polarity of sentiment, and leaves a keyword if the keyword includes additional sentiment information as well as polarity of sentiment, accuracy of a search result can be further improved. For example, in case of the sentiment keyword “exciting,” there may be a case where when only the extracted polarity code of “+1” is used for index search, a document, which is inconsistent with the sentiment of “exciting” while describing positive sentiment, receives a higher score than a document describing the sentiment of “exciting,” and is preferentially returned as a search result. The query parsing unit 410 can avoid this circumstance by leaving the sentiment keyword “exciting” in the query.

In this case, it would be preferable to expand a sentiment keyword, which is left in a query because of including additional sentiment information as well as polarity of sentiment, to its synonym or near-synonym. As described above, this is intended to allow that if a query includes, for example, the sentiment keyword “enjoyable,” a document describing opinion of “interesting,” as well as a document describing opinion of “enjoyable,” can be searched.

Meanwhile, the query processing unit 400 may search a code of a polarity weighting score of the corresponding keyword from the sentiment score dictionary. Thus, it is simple for the query processing unit 400 to calculate a polarity code in a keyword representing sentiment. In addition, since a query is searched based on whether a document describing opinion includes positive or negative sentiment, the query processing unit 400 does not need to compare each of a sentiment keyword, a near-synonym and a synonym with an index. Thus, the query processing unit 400 can quickly search a query, and process all various synonyms or near-synonyms, regardless of specific expressions of sentiment. That is, since the query processing unit 400 can thoroughly search opinion related to a query with a fast query processing speed, it is very effective and can improve accuracy of a search result.

A calculated polarity code may be used to reverse ranking of segments searched by the segment examining unit 420 according to the calculated polarity code. For example, reversing the ranking may be implemented by multiplying a score of each segment by the calculated polarity code.

There are many cases where a user searching a query searches other users' opinion for the purpose of receiving help when he/she makes a decision. Thus, in most cases, polarity of a sentiment keyword included in a query would be positive (“+”). For example, a user who desires to review other people's opinion to select a move to watch would generally search “a movie with good acting,” rather than “a movie with bad acting.” Accordingly, in an example embodiment, when no polarity is input, a basic value for a polarity code is set to “+1” to enable search of a document including positive sentiment. In addition, if a user searches “a movie with bad acting,” which includes negative sentiment, the ranking may be easily reversed by multiplying the result of searching the positive sentiment by the polarity code “−1.”

For the query of “a movie with bad acting,” the query parsing unit 410 may calculate a polarity code “−1,” instead of the negative sentiment keyword “bad.” The segment examining unit 420 first searches a segment describing positive sentiment as in the case where the query of “a movie with good acting” has been received. After searching the segment describing positive sentiment, the segment examining unit 420 may multiply the polarity code to reflect the polarity code. For example, if scores of Segments 1, 2 and 3 for “a movie with good acting” are “+0.2,” “+2” and “−1,” respectively, results of multiplying each of the scores by the polarity code “−1” will be “−0.2,” “−2” and “+1.” Thus, the segment examining unit 420 returns Segment 3 as a segment describing opinion having the highest relationship to the query of “a movie with bad acting.” This result may be as highly accurate as the case where Segment 2 is returned as a search result having the highest relationship to the query of “a movie with good acting.”

After the segment examining unit 420 searches a segment, of which segment contents include a keyword included in a parsed query, it finds an aspect-sentiment pair corresponding to an aspect keyword included in the parsed query from the searched segment. In addition, the segment examining unit 420 calculates an aspect-sentiment pair score of the searched segment, by summing up or averaging sentiment scores of the searched aspect-sentiment pairs or implementing other calculation. If the parsed query includes no aspect keyword, the segment examining unit 420 calculates an aspect-sentiment pair score by summing up or averaging sentiment scores of all aspect-sentiment pairs included in the searched segment or implementing other calculation. A sentiment score of an aspect-sentiment pair may be calculated by searching a polarity weighting score of sentiment included in the aspect-sentiment pair from the sentiment score dictionary. As described above, by multiplying a calculated aspect-sentiment pair score by a polarity code, a segment score of the corresponding segment is finally calculated.

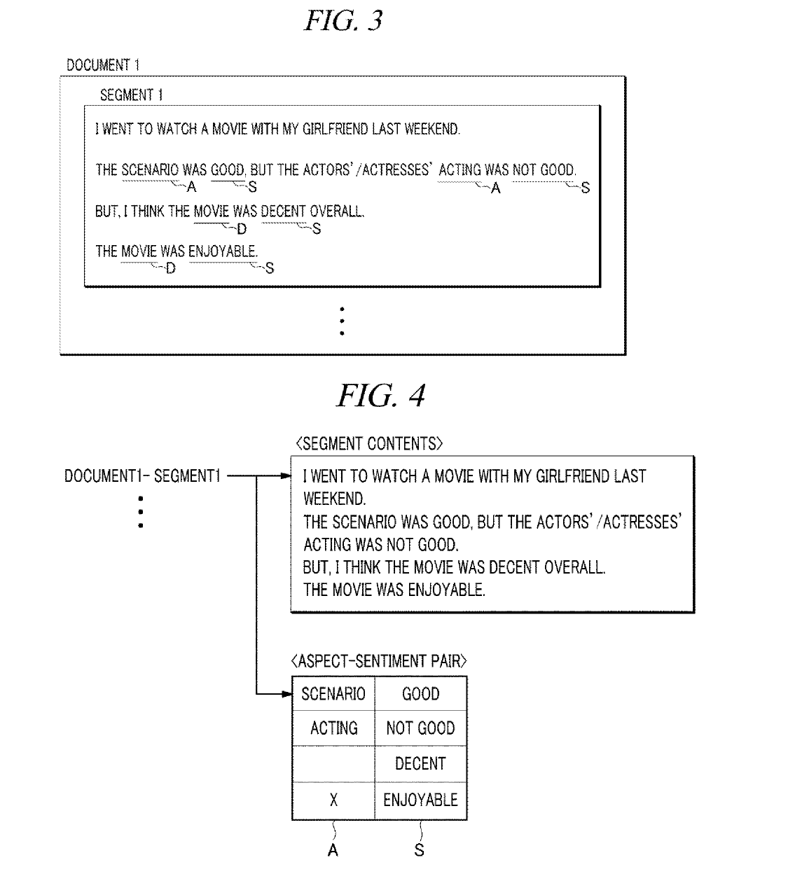

The sentiment-based query processing system 10 and method in accordance with an example embodiment is described in more detail with reference to the examples in FIG. 3 to FIG. 10.

FIG. 3 shows a document representing opinion in accordance with an example embodiment, and FIG. 4 shows segment contents included in a segment of FIG. 3 and aspect-sentiment pairs.

Illustrated Document 1 describes opinion on a movie. Document 1 includes Segment 1, which has the contents that “I went to watch a movie with my girlfriend last weekend. The scenario was good, but the actors′/actresses' acting was not good. But, I think the movie was decent overall. The movie was enjoyable.” As described above, Segment 1 has been obtained from the division into topic units. For convenience, the descriptions below only describe Segment 1. However, as described above, segment scores for the omitted segments will also be calculated, and scores of the corresponding segments will be used to calculate a score of Document 1.

Segment 1 includes the domain keyword (D) “movie.” As described above, a keyword representing a domain may be identically treated to a keyword representing an aspect in accordance with an example embodiment. “Scenario” and “acting” are aspect keywords (A), and “good,” “not good,” “decent” and “enjoyable” are sentiment keywords (S). Here, the keywords (S) representing sentiment are expressed in their basic forms because the index establishing unit 300 also implements necessary pre-processing like the query parsing unit 410 implementing pre-processing.

As in the parsing of a query, in an example embodiment, the sentiment-based query processing system 10 may exclude a domain keyword (D) when establishing an index. In another example embodiment, the sentiment-based query processing system (10) may treat a domain keyword (D) as an aspect keyword (A). FIG. 4 shows an example for an index, from which the domain keyword (D) “movie” is removed.

With reference to FIG. 4, the sentiment-based query processing system 10 generates an aspect-sentiment pair consisting of each of the aspect keywords (A) and its corresponding sentiment keyword (S), which have been extracted from Segment 1. Here, the aspect-sentiment pairs are included together with the segment contents in the index. In this case, FIG. 4 illustrates that the index includes the segment contents only for convenience in description, and a method for composing the index is not limited.

For example, the sentiment-based query processing system 10 may compose the index to include only information such as segment ID to approach the corresponding segment, and approach a document including Segment 1 by using the corresponding information, if necessary, to refer to contents of Segment 1. Also, a method for composing an aspect-sentiment pair is not limited.

In another example embodiment, the sentiment-based query processing system 10 may also store information about an object described by the corresponding segment in the index.

For convenience in description, only the example embodiment where one document describes one object has been descried; however, in another example embodiment, one document may describe at least one object.

That is, in an example embodiment where an object is returned as a search result, there is an advantage in that when information about an object described by the corresponding segment is also stored in the index, it is possible to immediately identify the object in the index upon processing a query. On the other hand, in an example embodiment where a document is returned as a search result, only information about a document (e.g., URL) may be stored without storing information about an object.

As described above, the method for composing the index and information included in the index are not limited.

However, it is preferable that an aspect keyword (A) and its corresponding sentiment keyword (S) are exactly paired with each other to be stored. For example, the sentiment keyword (S) “good” should correspond to the aspect keyword (A) “scenario,” rather than “the aspect keyword (A) “acting.”

However, a sentiment keyword (S) may be generated as an aspect-sentiment pair without an aspect keyword (A). For example, as illustrated, in the present example embodiment, the sentiment keyword (S) “enjoyable” has been extracted without its corresponding aspect keyword (A).

FIG. 5 to FIG. 7 show three (3) examples for a parsed query in accordance with an example embodiment.

FIG. 5 relates to a query including a positive sentiment keyword (S), and FIG. 6 relates to a query including a negative sentiment keyword (S). In addition, FIG. 7 relates to a query, which includes a positive sentiment keyword (S), but no certain aspect keyword (A).

As described above, the query parsing unit 410 implements pre-processing for a query. The query parsing unit 410 extracts keywords from the pre-processed query, and then, calculates polarity codes based on sentiment keywords (S). The query parsing unit 410 removes domain keywords (D) and sentiment keywords (S) representing only polarity from the extracted keywords.

With reference to FIG. 5, the polarity code “+,” i.e., “+1” is extracted by “good” in the user query. In addition, as a result of removing domain keywords (D) and sentiment keywords (S) from the user query, the parsed query is “acting.”

With reference to FIG. 6, the polarity code “−,” i.e., “−1” is extracted by “terrible” in the user query. In addition, as a result of removing domain keywords (D) and sentiment keywords (S) from the user query, the parsed query is “scenario.” In this case, FIG. 6 illustrates that the sentiment regarding the aspect of “evaluated” is excluded from the parsed query since it is a keyword, which does not significantly affect the query, but the keyword may not be removed in accordance with an example embodiment.

With reference to FIG. 7, the polarity code “+,” i.e., “+1” is extracted by “good” in the user query. In addition, as a result of removing domain keywords (D) and sentiment keywords (S) from the user query, the parsed query is “girlfriend, watch.”

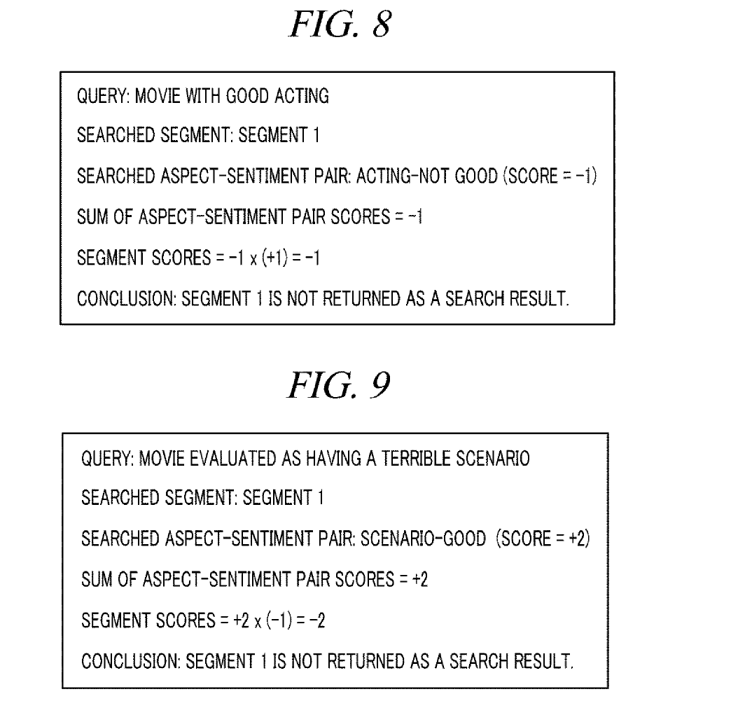

FIG. 8 to FIG. 10 illustrate an example for examining the segment of FIG. 4 with respect to the three (3) queries of FIG. 5 to FIG. 7.

As described above, the segment examining unit 420 searches the segment including the keywords included in the parsed query. That is, for the query of FIG. 5, the segment examining unit 420 searches a segment including “acting” in the contents of the segment. In addition, for the query of FIG. 6, the segment examining unit 420 searches a segment including “scenario” in the contents of the segment. For the query of FIG. 7, the segment examining unit 420 searches a segment including “girlfriend, watch” in the contents of the segment. All the results of FIG. 5 to FIG. 7 correspond to Segment 1 of FIG. 4.

For the searched segment, the segment examining unit 420 finds an aspect-sentiment pair corresponding to the aspect keyword (A) included in the parsed query. For example, for the query of FIG. 5, “acting-not good” is searched as an aspect-sentiment pair corresponding to the aspect keyword (A) “acting.” For the query of FIG. 6, “scenario-good” is searched as an aspect-sentiment pair corresponding to the aspect keyword (A) “scenario.” Since the query of FIG. 7 includes no aspect keyword (A), no aspect-sentiment pair is searched.

The segment examining unit 420 calculates an aspect-sentiment pair score based on a sentiment score of the searched aspect-sentiment pair. In this case, the calculating method is not limited. For example, summing up, averaging and other calculations may be used for the calculating method. For example, since only one aspect-sentiment pair of “acting-not good” has been searched for the query of FIG. 5, a sentiment score of the aspect-sentiment pair is calculated as an aspect-sentiment pair score. However, when two (2) or more aspect-sentiment pairs have been searched, an aspect-sentiment pair score may be calculated by summing up or averaging sentiment scores of the aspect-sentiment pairs.

As described above, a sentiment score of each aspect-sentiment pair may be calculated based on polarity and a weighting pre-defined in the sentiment score dictionary 200. For the sentiment of “not good” included in the aspect-sentiment pair of “acting-not good” searched for the query of FIG. 5, a sentiment score, which is calculated based on polarity and a weighting searched in the sentiment sore dictionary 200, is “−1.” In addition, for the sentiment “good” included in the aspect-sentiment pair of “scenario-good” searched for the query of FIG. 6, a sentiment score, which is calculated based on polarity and a weighting searched in the sentiment score dictionary 200, is “+2.”

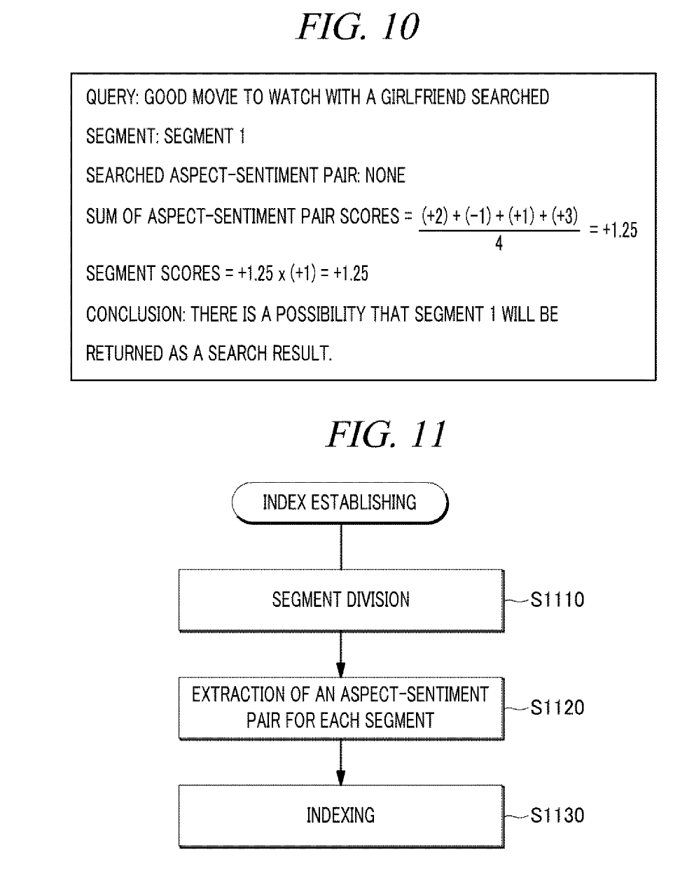

In case of the query of FIG. 7, there is no searched aspect-sentiment pair. In this case, an aspect-sentiment pair score is calculated based on sentiment scores of all aspect-sentiment pairs included in the searched segment. In this case, the calculating method is not limited. For example, summing up, averaging or other calculations may be used for the calculating method. Accordingly, the example illustrated in FIG. 10 has used averaging, and as a result, “+1.25” has been calculated as an aspect-sentiment pair score.

The case where no aspect-sentiment pair is searched includes the case where a query includes an aspect keyword (A), while a searched segment includes no aspect keyword (A) (not illustrated), as well as the case where a query includes no aspect keyword (A) like the query of FIG. 7. This corresponds to the case where the corresponding segment is searched matching with a keyword other than aspect keywords (A) included in the query. In this case as well, an aspect-sentiment pair score may be calculated based on sentiment scores of all the aspect-sentiment pairs included in the searched segment. That is, the aspect-sentiment pair score is calculated based on sentiment scores of all the sentiment keywords (S) included in the segment. In this case as well, the calculating method is not limited, and for example, summing up, averaging or other calculations may be used.

As described above, the segment examining unit 420 calculates a final segment score, by multiplying a sum of the calculated aspect-sentiment pair scores and the polarity code calculated by the query parsing unit 410. With reference to FIG. 8, since a sum pf the aspect-sentiment pair scores of the query of FIG. 5 is “−1,” and the polarity code is “+1,” the segment score is calculated to be “−1.” With reference to FIG. 9, since a sum of the aspect-sentiment pair scores of the query of FIG. 6 is “+2,” and the polarity code is “−1,” the segment score is calculated to be “−2.” With reference to FIG. 10, since a sum of the aspect-sentiment pair scores of the query of FIG. 7 is “+1.25,” and the polarity code is “+1,” the segment score is calculated to be “+1.25.”

Accordingly, in the examples of FIG. 8 and FIG. 9, the final segment score has negative polarity. Thus, Segment 1 may not be returned as a search result for the queries of FIG. 5 and FIG. 6. In the example of FIG. 10, since the segment score having positive polarity has been calculated, Segment 1 may be or may not be returned as a search result depending on a result of comparison with scores of the other segments. For example, if the score of Segment 2 is “+3,” Segment 2 has higher relationship to the query than Segment 1, and thus, Segment 2 will be preferentially returned to Segment 1.

In this case, Segment 1 has been described to be returned as a search result, but as described above, the query processing unit 400 actually examines relationship of a document including the segment or an object described by the segment with respect to the query based on the segment scores calculated by the segment examining unit 420. For example, if Document 1 has been divided into Segments 1 and 2, a score of Segment 1 is “+1.25,” and a score of Segment 2 is “+3,” a score of Document 1 may be “+2.125,” which is an average of the scores of Segments 1 and 2. In addition, if the calculating method uses summing up, the score of Document 1 may be “+4.25,” which is a sum of the scores of Segments 1 and 2. In addition, a value obtained by implementing other calculation according to preset summing-up calculation may be calculated. The finally calculated score of Document 1 is compared with scores of other documents. In this case, the query processing unit 400 returns a document with the highest value or an object describing the corresponding document as a search result.

Here, with respect to the method for returning an object related to a query as a search result, in addition to the method that groups and collects segment scores by documents and returns an object described by a corresponding document, there is a method that groups and collects segment scores by objects for at least one document. For example, if Segment 1 of Document 1 describes opinion on Movie 1, Segment 3 of Document 2 describes opinion on Movie 1, and segment scores calculated as a result of segment examination are “+1” and “2,” respectively, a score of Movie 1 may be “1.5,” which is an average of the two scores. In this case as well, summing up, averaging or other calculations may be used for the collecting calculation.

Through the above-described example embodiments, the sentiment-based query processing system 10 can effectively and accurately process various queries such as a query including a positive sentiment keyword (S) for an aspect keyword (A), a query including a negative sentiment keyword (S) for an aspect keyword (A) and a query including no certain aspect keyword (A). In addition, as described above, the sentiment-based query processing system 10 can effectively process a query including two (2) or more aspect keywords (A), though not described by using an example in the drawings.

Hereinafter, flow of a sentiment-based query processing method in accordance with an example embodiment is described with reference to FIG. 11 to FIG. 13.

First, FIG. 11 shows flow of a method for establishing an index in accordance with an example embodiment.

The sentiment-based query processing system 10 divides at least one document, which describes opinion on a certain object, such as online review, into segments in a topic unit (S1110). As described above, the method for dividing a document into segments is not limited. For example, the method for dividing a document into segments may be a technology drawn from the natural language processing field, or simply divide a document into a certain number of sentence units.

The sentiment-based query processing system 10 extracts an aspect-sentiment pair for each divided segment (S1120). The aspect-sentiment pair is obtained by extracting opinion writher's sentiment regarding an aspect of an object, and pairing an aspect keyword (A) and a sentiment keyword (S) with each other. In this case, as described above, the relationship between the aspect keyword (A) and the sentiment keyword (S) should be exact. To this end, as described above, the index establishing unit 300 parses each segment, and implements necessary pre-processing prior to the parsing. For example, the expression “good” is extracted as a sentiment keyword (S) in a basic form, i.e., “good.”

In addition, the sentiment-based query processing system 10 establishes and stores an index including the segment contents and the extracted aspect-sentiment pairs (S1130).

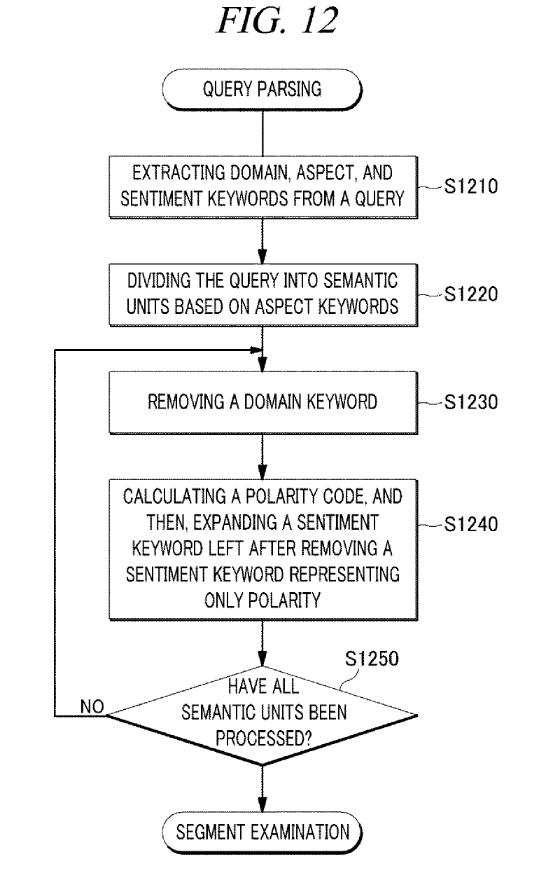

FIG. 12 shows flow of a method for parsing a query in accordance with an example embodiment.

When a query is received, the sentiment-based query processing system 10 extracts a domain keyword (D), an aspect keyword (A) and a sentiment keyword (S) from the query (S1210). To this end, as described above, the sentiment-based query processing system 10 parses the query, and implements necessary pre-processing prior to the parsing. For example, the expression “good” is extracted as a sentiment keyword (S) in a basic form, i.e., “good.”

Next, the sentiment-based query processing system 10 divides the query into semantic units based on the aspect keyword (S1220). For example, since a query of “a movie with good scenario and acting” includes two (2) semantic units, i.e., “scenario is good,” and “acting is good,” the query is divided into the semantic units as described above. After dividing the query into the semantic units, the sentiment-based query processing system 10 may process each of the semantic units to obtain results, and integrate the results.

Next, when an index is established only for an object in a certain domain, the sentiment-based query processing system 10 removes the domain keyword (D) (S1230). For example, if an index has been established only for documents describing opinion on a movie, the keyword “movie” is commonly included in all the documents and unnecessary, and thus, the keyword is removed from the query. However, if the index has been established for various domains such as movies, books and TV programs, the keyword “movie” is regarded and processed as an aspect keyword (A).

Next, the sentiment-based query processing system 10 removes the sentiment keyword (S) representing only polarity after calculating a polarity code (S1240). As described above, removing the sentiment keyword (S) representing only polarity from the query after considering only the polarity code is intended to process all synonyms or near-synonyms without additionally expanding synonyms or near-synonyms. As described above, since the sentiment-based query processing system 10 has only to consider the polarity code, it can significantly simplify the query processing process. Further, since the sentiment-based query processing system 10 does not result in omission of a document related to a query, it can further improve accuracy of search results. However, as described above, the sentiment-based query processing system 10 does not remove a sentiment keyword (S) representing additional sentiment information, further to polarity, from the query. Instead, it is preferable to expand the keyword to its synonym or near-synonym. For example, since “good” represents only polarity, it can be removed from the query. However, since “enjoyable” includes additional sentiment information, further to polarity, it is not removed from the query, and may be expanded to “interesting.”

The sentiment-based query processing system 10 repeats S1230 and S1240 until all the semantic units are processed (S1250), and when the processing is completed, segment examination is proceeded with.

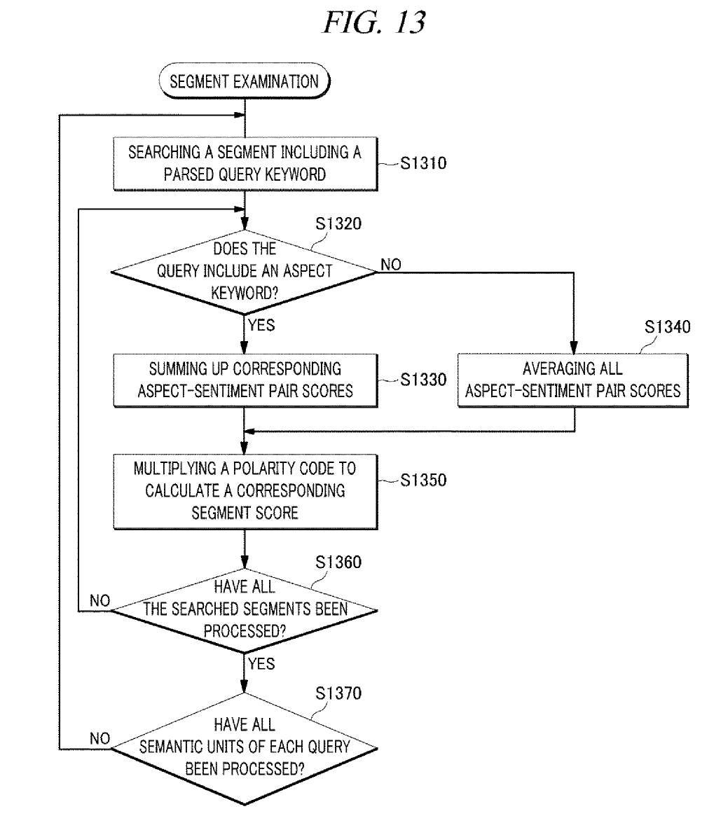

FIG. 13 shows flow of a method for examining a segment in accordance with an example embodiment.

The sentiment-based query processing system 10 searches a segment including the parsed query keywords (S1310). In this case, the sentiment-based query processing system 10 searches the index to extract segments including the corresponding keywords in their segment contents.

Next, if the query includes an aspect keyword (S1320), the sentiment-based query processing system 10 sums up sentiment scores of the corresponding aspect-sentiment pairs (S1330). However, if no aspect keyword is included (S1320), the sentiment-based query processing system 10 averages sentiment scores of all the aspect-sentiment pairs (S1340), so as to calculate an aspect-sentiment pair score of the searched segment. In this case, as described above, a calculation other than summing up or averaging may be used in S1330 and S1340. In addition, the sentiment scores of the aspect-sentiment pairs may be calculated by searching a polarity weighting of the corresponding sentiment keyword (S) from the sentiment score dictionary 200 by using the sentiment keywords (S) included in the aspect-sentiment pairs.

Next, the sentiment-based query processing system 10 calculates a score of the corresponding segment by multiplying a polarity code (S1350). As described above, through the simple stage of multiplying a polarity code to reverse the ranking of the search results, the sentiment-based query processing method in accordance with an example embodiment can easily apply the result obtained from searching opinion having positive sentiment to the result obtained from searching opinion having negative sentiment.

The sentiment-based query processing system 10 repeats S1320 to S1350 until all the searched segments for the parsed query are processed (S1360). When the processing of the parsed query is completed, the sentiment-based query processing system 10 repeats S1310 to S1360 until all parsed queries different from the parsed query, for which the processing has been completed, are processed (S1370).

Although not illustrated, as described above, the calculated segment score is used to calculate a score of a document or a score of an object. Thus, the sentiment-based query processing system 10 can return a document having a high document score as a search result. Or, the sentiment-based query processing system 10 may sum up the scores of the segments matching the query by objects described by the corresponding segments to return an object having a high score as a search result.

Meanwhile, since the sentiment-based query processing system 10 of FIG. 1 is merely an example embodiment of the present disclosure, the present disclosure should not be construed as being limited to FIG. 1. That is, according to various example embodiments of the present disclosure, the sentiment-based query processing system 10 may be differently configured from FIG. 1, as specifically described hereinafter.

The sentiment-based query processing system 10 in accordance with another example embodiment includes a memory and a processor.

The memory stores a sentiment-based query processing program. In this case, the memory 210 generally refers to a nonvolatile storing device, which continuously holds stored information even when no power is supplied, and a volatile storing device, which requires electricity to hold stored information.

The processor may divide at least one document into at least one segment, as the program stored in the memory is executed. In addition, the processor may generate an aspect-sentiment pair by extracting an aspect keyword representing an aspect of an object of opinion described in the divided segment and a sentiment keyword representing document writer's sentiment regarding the aspect. In addition, the processor may establish an index including contents of the segment and the aspect-sentiment pair and store the index in the memory.

In addition, the processor may process a query based on the index stored in the memory. The processor may also search and return a document describing opinion related to the query or an object described by opinion related to the query.

Such a processor may implement the same performance as that of the index establishing unit 300 and the query processing unit 400. In addition, the memory may implement the same performance as that of the index storing unit 100 and the sentiment score dictionary 200 to store the index and the sentiment score dictionary.

Example embodiments can be embodied in a storage medium including instruction codes executable by a computer or processor such as a program module executed by the computer or processor. A computer readable medium can be any usable medium which can be accessed by the computer and includes all volatile/nonvolatile and removable/non-removable media. Further, the computer readable medium may include all computer storage and communication media. The computer storage medium includes all volatile/nonvolatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes information transmission mediums.

The method and the system of the example embodiments have been described in relation to the certain examples. However, the components or parts or all the operations of the method and the system may be embodied using a computer system having universally used hardware architecture. A hardware system, which is an example for a computer system architecture that can be used to execute at least one component or operation of example embodiments, may include a processor, a cache, a memory and at least one software application and driver related to the above-described function.

Additionally, the hardware system includes a high-performance input/output (I/O) bus and a standard I/O bus. A host bridge connects a processor to the high-performance I/O bus, and an I/O bus bridge connects two (2) buses to each other. A system memory and a network/communication interface are connected to the high-performance I/O bus. The hardware system may further include a video memory and a display device connected to the video memory. A mass memory device and an I/O port are connected to the standard I/O bus. The hardware system may selectively include a keyboard, a pointing device and a display device connected to the standard I/O bus. Generally, these components are intended to represent a broad scope of a computer hardware system, and include, but is not limited to, a widely used computer system based on other proper processors as well as the Pentium Processor manufactured by Intel Corporation.

The components of the hardware system are described hereinafter in more detail. More specifically, network interface provides communication between the hardware system and a broad scope of a random network like Ethernet (e.g., IEEE 802.3) network or others. In an example embodiment, the network interface accesses between hardware systems and a network such that the hardware systems manage their databases. The mass memory device provides a permanent memory device for data and programing instructions to implement the above-described function embodied in example embodiments, and the system memory (e.g., DRAM) provides a temporary memory device for data and programing instructions when it is executed by a processor. The I/O port is at least one series and/or parallel communication port providing communication between additional peripheral devices.

The hardware system may include various types of system architectures, and various components of the hardware system may be rearranged. For example, the cache may be equipped in the processor. Alternatively, the cache and the processor may be grouped together as a “processor module,” and in this case, the processor may be called a “processor core.” In addition, a certain example embodiment may not require or include all the above-described components. For example, peripheral devices illustrated to be connected to the standard I/O bus may be connected to the high-performance I/O bus. Additionally, in an example embodiment, only one bus may exist, and the components of the hardware system may be connected to the bus. Further, the hardware system may include additional components such as an additional processor, a memory device or a memory. As described hereinafter, operation of an example embodiment may be implemented as a series of software routines driven by the hardware system. These software routines include a multiple number or a series of instructions that can be executed by the processor in the hardware system. Above all, the series of instructions are stored in a memory device like the mass memory device. However, the series of instructions may be stored in any proper memory medium like a diskette, CD-ROM, ROM, EEPROM and others. Further, the series of instructions do not need to be locally stored, and may be received from a remote memory device like a server on a network through network/communication interface. The instructions are copied from a memory device like a mass memory device to a system memory, and accessed and executed by a processor.

The operation system manages and controls the operation of the hardware system including data input/output with a software application. The operation system provides interface between the software application executed in the system and the hardware components of the system. The operation system in accordance with example embodiments may be the Windows 95/98/NT/XP/VISTA operation system of Microsoft Corporation. However the example embodiments may be also used in other proper operations systems such as the Apple Macintosh operation system of Apple Computer Inc., the UNIX operation system, and the LINUX operation system.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the example embodiments. It shall be understood that all modifications and embodiments conceived from the meaning and scope of the claims and their equivalents are included in the scope of the inventive concept.

We claim:

1. A sentiment-based query processing system, comprising:
an index establishing unit that divides at least one document into at least one segment, generates an aspect-sentiment pair by extracting an aspect keyword representing an aspect of an object of opinion described in the segment and a sentiment keyword representing document writer's sentiment regarding the aspect, and establishes an index including contents of the segment and the aspect-sentiment pair;
an index storing unit that stores the index; and
a query processing unit that processes a query based on the index stored in the index storing unit, so as to search and return a document describing opinion related to the query or an object describing opinion related to the query.

2. The sentiment-based query processing system of claim 1,
wherein the segment is divided to include at least one minimum phrase, clause, or sentence, which has identical semantic relationship.

3. The sentiment-based query processing system of claim 1,
wherein the query processing unit comprises:
a query parsing unit that implements parsing of the query; and
a segment examining unit that examines relationship between each of the segments included in the index and the query based on the contents of the segments and the aspect-sentiment pair.

4. The sentiment-based query processing system of claim 3,
wherein the query processing unit examines relationship between a document including the segment or an object described by the segment and the query by summing up segment scores calculated by the segment examining unit.

5. The sentiment-based query processing system of claim 3,
wherein the query parsing unit calculates a polarity code of the query based on keywords representing sentiment in the query, and removes a keyword representing only polarity of sentiment from the keywords representing sentiment.

6. The sentiment-based query processing system of claim 3,
wherein the query parsing unit removes a keyword representing a domain, to which the object belongs, from the query.

7. The sentiment-based query processing system of claim 3,
wherein the query parsing unit divides the query into at least one semantic unit based on a keyword representing an aspect, and
the segment examining unit calculates a segment score for each of the divided semantic units.

8. The sentiment-based query processing system of claim 3,
wherein the segment examining unit searches a segment, of which segment contents includes the keywords included in the parsed query, and then, finds an aspect-sentiment pair corresponding to an aspect keyword from the keywords included in the parsed query, and multiples the aspect-sentiment pair score calculated based on a pre-calculated sentiment score of the searched aspect-sentiment pair by the calculated polarity code of the query to calculate a segment score of the searched segment.

9. The sentiment-based query processing system of claim 3,
Wherein when the parsed query includes no aspect keyword, the segment examining unit calculates an aspect-sentiment pair score based on pre-calculated sentiment scores of all aspect-sentiment pairs included in the searched segment.

10. The sentiment-based query processing system of claim 3,
wherein the system further comprises a sentiment score dictionary that stores a polarity weighting score pre-designated for each sentiment keyword; and
the segment examining unit calculates the aspect-sentiment pair score, by searching a polarity weighting score of sentiment included in the aspect-sentiment pair from the sentiment score dictionary.

11. A sentiment-based query processing method using a sentiment-based query processing system, comprising:
(a) dividing at least one document into at least one segment including at least one minimum phrase, clause or sentence having identical semantic relationship;
(b) generating an aspect-sentiment pair by extracting an aspect keyword representing one aspect of an object in opinion described in the segment and a sentiment keyword representing document writer's sentiment regarding the aspect;
(c) establishing an index including contents of the segment and the aspect-sentiment pair;
(d) implementing parsing of a received query, so as to calculate a polarity code of the query based on keywords representing sentiment in the query, and remove a keyword representing only polarity of sentiment from the keywords representing sentiment;
(e) examining relationship between each segment included in the index and the query based on the contents of the segment and the aspect-sentiment pair to calculate a segment score; and
(f) summing up the segment scores calculated by the segment examining unit to examine relationship of the document or object to the query.

12. The sentiment-based query processing method of claim 11,
wherein the process (d) removes a keyword representing a domain, to which the object belongs, from the query.

13. The sentiment-based query processing method of claim 11,
wherein the process (d) divides the query into at least one semantic unit based on a keyword representing an aspect, and
the process (e) calculates a segment score for each of the divided semantic units.

14. The sentiment-based query processing method of claim 11,
wherein the process (e) comprises:
(e1) searching a segment, of which segment contents include a keyword included in the parsed query;
(e2) finding an aspect-sentiment pair corresponding to an aspect keyword included in the parsed query from the searched segment, and calculates an aspect-sentiment pair score of the searched segment based on a sentiment sore of the searched aspect-sentiment pair; and
(e3) calculating the segment score based on the polarity code and the aspect-sentiment pair score.

15. The sentiment-based query processing method of claim 14,
wherein when the parsed query includes no aspect keyword, the process (e2) calculates an aspect-sentiment pair score based on pre-calculated sentiment scores of all aspect-sentiment pairs included in the searched segment.

16. The sentiment-based query processing method of claim 14,
wherein the process (e2) calculates the aspect-sentiment pair score, by searching a polarity weighting score of sentiment included in the aspect-sentiment pair from the sentiment score dictionary.
